(19) United States
(12) Patent Application Publication
(10) Pub. No.: US 2023/0366308 A1
(43) Pub. Date: Nov. 16, 2023

(54) COMPUTER-IMPLEMENTED METHOD FOR DETERMINING AN OPERATING PROPERTY OF A PUMPJACK, ANALYSIS DEVICE AND PUMP SYSTEM THEREFOR

(71) Applicant: Siemens Energy Global GmbH & Co. KG, Munich, Bayern (DE)

(72) Inventors: Stefan Gschiel, Vienna (AT); Helmut Wimmer, Güssing (AT); Helmut Schnabl, Melk (AT)

(73) Assignee: Siemens Energy Global GmbH & Co. KG, Munich, Bayern (DE)

(21) Appl. No.: 18/030,864

(22) PCT Filed: Sep. 24, 2021
(86) PCT No.: PCT/EP2021/076393

§ 371 Date: Apr. 7, 2023

(30) Foreign Application Priority Data
Oct. 15, 2020 (EP) 20202027.7

(51) Int. Cl. E21B 47/009; E21B 43/12

(52) U.S. Cl. CPC E21B 47/009; E21B 43/127; E21B 2200/22

(57) ABSTRACT

A computer-implemented method for determining an operating property of a pumpjack, wherein the pump has a pump head, which is connected to a kinematic converter via a rod system, and the kinematic converter is driven by a motor during operation and a load-travel graph containing curve points is determined for the delivery pump by an analysis device using recording and is provided as an operating load-travel graph containing operating curve points.

### CROSS REFERENCE TO RELATED APPLICATIONS

This application is the US National Stage of International Application No. PCT/EP2021/076393 filed 24 Sep. 2021, and claims the benefit thereof. The International Application claims the benefit of European Application No. EP20202027 filed 15 Oct. 2020. All of the applications are incorporated by reference herein in their entirety.

### FIELD OF INVENTION

The invention relates to a computer-implemented method for determining an operating property of a pumpjack, wherein the pump has a pump head, which is connected to a kinematic converter via a rod system, and the kinematic converter is driven by a motor during operation and a load-travel graph containing curve points is determined for the delivery pump by an analysis device using a recording means and is provided as an operating load-travel graph containing operating curve points.

The invention also relates to a computer program, an electronically readable data carrier and a data carrier signal.

The invention additionally relates to an analysis device having a memory and to a pump system for determining an operating property of a pumpjack.

### BACKGROUND OF INVENTION

Subsurface pumps or delivery pumps are employed as conveyors for extracting subterranean liquids when the reservoir pressure is not sufficient for them to reach the surface independently, or in sufficient quantity. They are predominantly used to convey crude oil. Other areas of use are the conveyance of saltwater and healing waters.

The image of most oilfields is characterized by pumpjacks, the appearance and motion of which mean that they are also called horsehead pumps, nodding donkeys or nodding jennys. The actual pump mechanism—a plunger having nonreturn valves—is located in its own pipe section in the well close to the oil-bearing layer. The plunger is set in a continuous up-and-down motion by a pumping unit located on the surface of the earth by means of a boltable rod. This is accomplished by the so-called horsehead. This consists of a at the end of a circular arc segment that is arranged as a beam and to which a steel-cable or chain pair is clamped at the top.

Propulsion is provided electrically for the most part. When sufficient energy-containing gases dissolved in the crude oil are present, however, a portion of these gases can be separated from the conveyed material by means of a degasser there and then, and supplied to a gas-powered motor that drives the pump.

Depending on the pump design and size, the power stroke is between 1 and 5 m. Between two and a half and twelve strokes per minute are customary. The pumpjack can be employed efficiently down to pumping depths of approximately 2500 m. Other pump systems are more suitable for greater depths on account of the great weight of the column of liquid that needs to be lifted.

The “Mark II” pump type from the Texan manufacturer Lufkin Industries is particularly suitable for high pumping rates from great depths as a result of its special movement geometry.

The “sucker rod” pump type has a sucker rod, that is to say a steel rod having a typical length of between 25 and 30 feet and a thread at both ends, which is used in the oil industry to connect the surface and well components of a reciprocating plunger pump installed in an oil source to one another.

An extremely valuable instrument for analyzing well yield is a well test rig, which measures the loading of the polished rod in relation to the position of the polished rod.

Dynamometers can be used to record rod position and rod load over time. The load-measuring part of the dynamometer is mounted on the polished rod so that the load can be measured and sent to a recorder. An accompanying part of the yield test rig mounted on the lifting beam detects the position of the polished rod and sends it to the same recorder. The chart produced is referred to as a dynagraph or more frequently as a dynamometer or dynagraph card and is equivalent to a load-travel graph.

Dynamometer cards taken at the surface can seldom be used directly for detecting the operating conditions of the well pump because they also reflect all forces (static and dynamic) that occur from the pump up to the wellhead. If a dynamometer is situated directly above the pump, however, the recorded card is a true indicator of pump operation. This is what Gilbert's dynagraph (a mechanical dynamometer) accomplished in the 1930s. Rod loads directly above the pump, recorded as a function of pump position, give dynagraph cards a name that distinguishes them from surface cards. Although the use of Gilbert's dynagraph allowed a direct investigation of pumping problems, the practical repercussions that were associated with the need to run the instrument in the well had far outweighed its advantages.

To date, the operating conditions of a pumpjack have been detected using sensors that record the forces which are acting, or the present attitude (inclination) of the walking beam (or crank arm), for example using force sensors, Hall sensors or proximity sensors. These are used to calculate the position of the rod system. However, calibrating the respective sensors with one another is complex. Moreover, inaccurate calibration can result in errors that can adversely affect the evaluation of measurement data.

### SUMMARY OF INVENTION

It is an object of the invention to provide a method and a device for determining operating properties of a pumpjack, wherein the operating conditions are determined in a simple and reliable manner, and with a high level of accuracy, with the result that comprehensive diagnosis of an operating state can take place.

The object according to the invention is achieved by way of a method of the type cited at the outset, wherein in a training mode the analysis device provides at least one model load-travel graph containing respective model curve points, which graph is normalized to a predefined reference variable, and at least two subsets of the model curve points are recorded as a first and at least one second feature on the basis of machine learning, and the first and the at least one second feature are produced and trained in the form of at least one random forest model using a Kmeans algorithm, and in an operating mode the operating curve points are normalized to the reference variable and a check is performed to ascertain whether there is a similarity between at least one subset of the operating curve points and the at least one random forest model, and, if so, the operating property of the pump is determined therefrom.

The effect achieved thereby is that one or more model load-travel graphs from other pumps can be used and, by way of example, a recently commissioned pump can be used immediately, that is to say without prior training using its own operating load-travel graphs.

Furthermore, features permitting an operating property of the pump to be inferred can be identified in a particularly simple manner.

An elliptical Fourier transformation can be used for the normalization.

Differences between the operating load-travel graph and the load-travel graph model, that is to say the training model, can be identified as an undesirable operating property of the pump itself, for example.

Similarly, a currently recorded pumped medium conveyed by the pump can be identified by way of comparison with an applicable training model that describes this very medium.

Consequently, both the operation of the pump with its components and the pumped medium conveyed are able to be analyzed efficiently and reliably.

The pumped medium is generally a mixture of gas, sand/stone particles, water, oil and in some cases also chemical additives.

The effect achieved thereby is that the operating conditions of the pump can be provided in a simple and reliable manner by being able to use machine learning to use a pump model that incorporates empirical values and forecasts relating to other pumps in the analysis.

This allows the accuracy for the determination and a diagnosis of an operating state to be improved.

The normalization of the load-travel graph model, which can be described by an appropriate graph, and of the operating load-travel graph allows the reciprocal comparison to be performed simply and accurately.

The normalization involves performing an axis adjustment in the load-travel graph, as is familiar to a person skilled in the art, so that a comparison of the curve shape is directly possible.

This allows data relating to other pumps and other pump types to be taken into account in the load-travel graph model, and therefore an appropriate load-travel graph model is available very quickly after a new pump is commissioned.

The formation of a “subsurface dynachart”, that is to say an operating load-travel graph for the pump head operating underground, allows the dependency of the pump type used, that is to say of a different pump design from that in the previously indicated method that was used, to be eliminated.

This can be accomplished for example by applying a finite element calculation and an FFT to a “surface dynachart”, that is to say an operating load-travel graph, relating to the whole pump system.

This allows laborious training of the load-travel graph model in situ to be reduced or even dispensed with completely.

It is advantageous if, after a similarity check by means of one or more Kmeans decision trees, an additional check is performed by subsequently establishing whether a curve formed by the operating curve points encloses one or more reference points produced using machine learning. This is illustrated in more detail in the associated exemplary embodiment. This allows operating properties to be identified particularly consistently.

In one development of the invention, there is provision for at least two random forest models to be formed that have a low correlation with respect to one another.

The effect achieved thereby is that features are identified independently of one another, increasing the probability of identification when determining the operating property of the pump.

In one development of the invention, there is provision for the at least two random forest models having low correlation to be produced by randomly selecting a respective point from the set of operating curve points and providing said point from the set of operating curve points using substitution.

This is advantageous because the features are identified reliably, increasing the probability of identification when determining the operating property of the pump.

In one development of the invention, there is provision for the at least two random forest models having low correlation to be produced by continuing to take a subset into account for breaking up a node in a random forest model.

This is advantageous because the features are identified reliably, increasing the probability of identification when determining the operating property of the pump.

In one development of the invention, there is provision for a sequence of the first and the at least one second feature within a pump cycle during operation of the pump in the respective random forest model to be taken into account for determining the operating property of the pump.

This is advantageous because a feature sequence within a curve characteristic, that is to say during a delivery cycle of the pump, further increases the probability of identification when determining the operating property of the pump.

In one development of the invention, there is provision for the first or the at least one second feature to comprise an interval between operating curve points in the operating load-travel graph (DC1-DC5).

The interval between operating curve points represents the local speed and the acceleration of the pump.

A further criterion that can be used besides the local speed can also be the local acceleration at a respective operating curve point, which can be described mathematically by the first or by the second derivative of the curve function for the two axes of the curve.

This allows the probability of identification to be increased when determining the operating property of the pump.

In one development of the invention, there is provision for the motor to be electrically operated and for there also to be provision for a recording means to record the power consumption of the motor during the operation thereof, from which power consumption the operating properties of the delivery pump are determined.

This allows the recording of the load-travel graph to be simplified, the accuracy for determining the curve points to be increased at the same time and, as a result of the combination with the aforementioned analysis method, the accuracy for determining the operating property to be improved further overall.

In one development of the invention, there is provision for the measurement curve points and the model curve points to each have intervals between two adjacent points on the respective curves that are on average at least 50%, preferably at least 80% and particularly preferably at least 95% of the greatest interval between two adjacent points on the respective curve.

In other words, it is advantageous if the majority of the points are equidistant from the respective adjacent curve points, that is to say the curve points that follow one another directly in the sequence thereof.

The equidistant intervals between the curve points can be considered to be interval differences of up to 20% of a respective interval between two successive points.

The sequence of the curve points is obtained when they are recorded, for example.

This allows singularities of curve points for the load-travel graph to be reduced, allowing the reference point to be determined more robustly and more accurately and the accuracy for determining the operating property to be improved further.

The object according to the invention is achieved by way of a computer program, comprising instructions that, when executed by a computer, cause said computer to carry out the method according to the invention.

The object according to the invention is achieved by way of an electronically readable data carrier having readable control information stored thereon, which control information comprises at least the computer program according to the invention and is configured in such a way that it performs the method according to the invention when the data carrier is used in a computing apparatus.

The object according to the invention is achieved by way of a data carrier signal that transmits the computer program according to the invention.

The object according to the invention is also achieved by way of an analysis device having a memory of the type cited at the outset, designed to analyze a provided operating load-travel graph using the method according to the invention and to ascertain the operating property therefrom.

The analysis device has two operating modes, specifically a training mode and an operating mode.

The training mode is used for producing and training a load-travel graph model of the pump, dedicated load-travel graph models being able to be trained for multiple operating modes of the pump in order to identify these modes accordingly.

The training mode is performed at the start of operation of the pump system in order to render one or more load-travel graph models available for the subsequent operating mode, in which the ongoing operation of the pump system can be continually monitored by the analysis device, on the basis of machine learning (ML).

The operating mode is used to compare a currently recorded dataset in the form of measurement points recorded by a recording means with a selected load-travel graph model, for example, and, in the event of a match with the load-travel graph model, to identify the operating mode associated with this model.

Furthermore, a change in the identified operating property can suggest a further parameter for the operating property.

As such, for example a sequence in the change in identified operating media can provide an indication of whether there is a material inhomogeneity in the medium.

For example, it would also be possible to identify whether there is a defect in components of the pump if a changed pattern of movement for the pump head has been identified only in upward movements.

The object according to the invention is also achieved by way of a pump system of the type cited at the outset, wherein the pump has a pump head, which is connected to a kinematic converter via a rod system, and the kinematic converter is driven by a motor during operation, and a recording means, designed to record and provide a load-travel graph relating to the pump containing curve points, and also the analysis device having a memory according to the invention, designed to ascertain the operating property from the provided operating load-travel graph.

### BRIEF DESCRIPTION OF THE DRAWINGS

The invention is explained in more detail below on the basis of an exemplary embodiment that is shown in the accompanying drawings, in which

FIG. 1 shows an exemplary embodiment of a system according to the invention with a pumpjack,

FIG. 2 shows an exemplary embodiment of a pump head of a pumpjack,

FIG. 3 shows an exemplary embodiment of a flowchart for a method for determining a load-travel graph from the power consumption of an electrically operated pump motor,

FIG. 4 shows a first exemplary embodiment of a load-travel graph,

FIG. 5 shows load-travel graphs for a pump for different powers,

FIG. 6 shows load-travel graphs for a pump for different loads and operating modes,

FIG. 7 shows a temporal representation of a current characteristic of an electric drive motor for a pumpjack,

FIG. 8-12 show examples of operating load-travel graphs containing curve points.

### DETAILED DESCRIPTION OF INVENTION

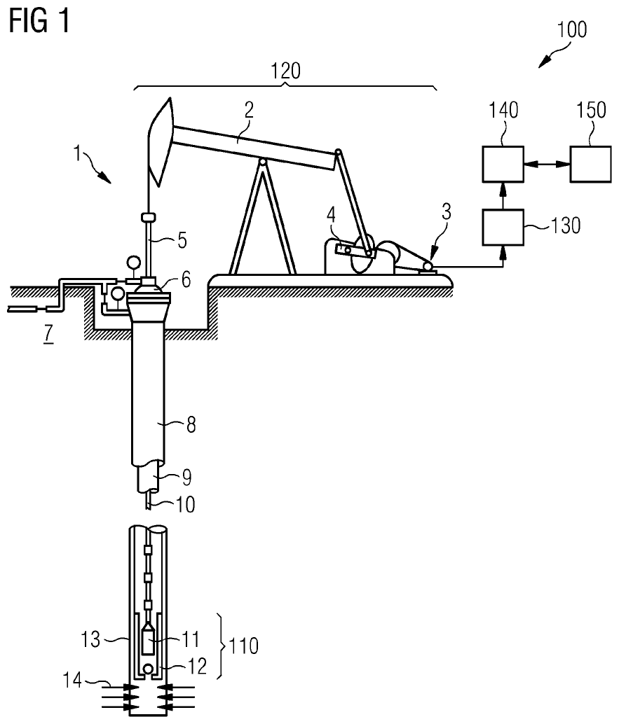

FIG. 1 shows an exemplary embodiment of a pump system 100 according to the invention with a pumpjack 1 of sucker rod pump type.

The pump system 100 comprises a pump head 110, which is connected to a kinematic converter 120 via a rod system 5, 10.

The rod system 5, 10 forms a so-called “rod string” and runs through a wellhead 6, to which a flowline 7 for drawing off a conveyed medium 14 is connected.

The wellhead 6 is adjoined by a casing 8, in which a tubing 9 that guides the rod system 5 or 10 runs.

Attached to the lower end of the rod system 10 is the pump head 110, which contains a plunger 11 in a barrel 12. A movement by the plunger 11 results in the conveyed medium 14 being pumped away.

The casing 8 is formed in a well 13.

The kinematic converter 120 is driven for example by a prime mover in the form of an electric motor 3 via a gear reducer 4. The kinematic converter 120 can additionally comprise a hydraulic force amplifier.

The mechanical link for the kinematic converter 120 is provided in this example by way of a walking beam 2, but can vary depending on the pump type used.

A person skilled in the art is familiar with such kinematic converters, as with the description thereof, in the form of “properties of a kinematic converter”, by the transformation function of mechanical movements and forces.

The kinematic converter 120 converts a rotational movement of the motor 3 into a linear movement of the rod system 5, 10.

The properties of the kinematic converter 120 can be described for example by way of lever actions and translations, and also by way of the electrical drive power and moving masses. It should be remembered that the position of a flywheel mass along a rotational movement and the corresponding force effect on the rod system 10 have a temporal relationship, referred to as the reference phase angle. A reference phase angle can be determined for a respective pump arrangement by applying the kinematic principles of mechanics, as is known to a person skilled in the art.

Furthermore, there is provision for a recording means 130, which is designed to record the current draw and the operating voltage of the individual phases of the motor 3 during the operation thereof. This can be achieved by way of an ammeter or voltmeter, for example, which records discrete measurement points containing current or voltage values in particular with high temporal resolution.

The recorded current and operating voltage values can be used to determine the effective power consumption and the apparent power consumption.

Furthermore, there is provision for an analysis or computing device 140 having a memory 150, designed to carry out the method according to the invention using the recording means 130.

A person skilled in the art knows how a reference phase angle can be ascertained for the kinematic converter 120 by using the properties of the kinematic converter 120 and the power consumption 72 of the motor 3, which reference phase angle describes the relationship between the maximum 83 of the power consumption 72 and the maximum of the force acting on the rod system of the subsurface pump 1.

A person skilled in the art also knows how a torque characteristic can be ascertained from the power consumption 72 of the motor 3 by using the properties of the kinematic converter 120.

The recording means 130 is designed to record an operating load-travel graph for the pump 1 containing curve points and to provide it to the computing or analysis device 140 having the memory 150.

The analysis device 140 is designed to analyze the provided operating load-travel graph using the method according to the invention and to ascertain the operating property therefrom.

The method according to the invention can be implemented as a computer program comprising instructions that, when executed by a computer 140, cause said computer to carry out the method according to the invention.

Furthermore, the method according to the invention can be available as an electronically readable data carrier having readable control information stored thereon, which control information comprises at least the computer program according to the invention and is configured in such a way that it performs the method according to the invention when the data carrier is used in a computing apparatus 140.

The method according to the invention can also be available as a data carrier signal that transmits the computer program according to the invention.

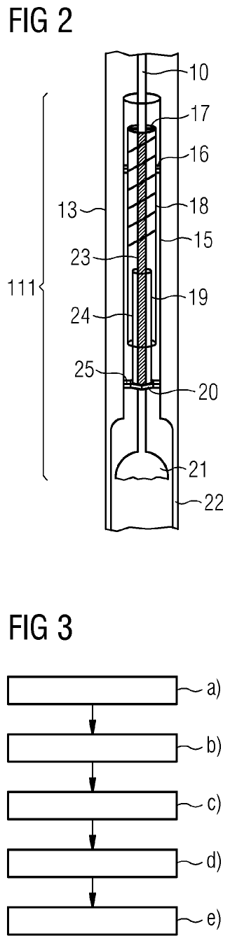

FIG. 2 shows a further, more detailed example of a pump head 111 according to the prior art.

The rod string, or the rod system 10, is driven in accordance with FIG. 1 and set in an up-and-down linear motion.

In the variant of the pump head 111 that is shown, the well 13 contains a cover tube 15 with vertical grooves that, inside the cover tube 15, guides a rotating tube 18 with spiral grooves by way of a retaining device 16 and a self-aligning bearing 17.

A recording tube 19 is connected by way of a winged nut 20 to a plunger assembly 21 located in a pump liner 22.

A calibrated rod 23 is connected by way of a stylus 24 and a retaining device 25 to the rod system 10, which drives the plunger assembly by way of the linear movement.

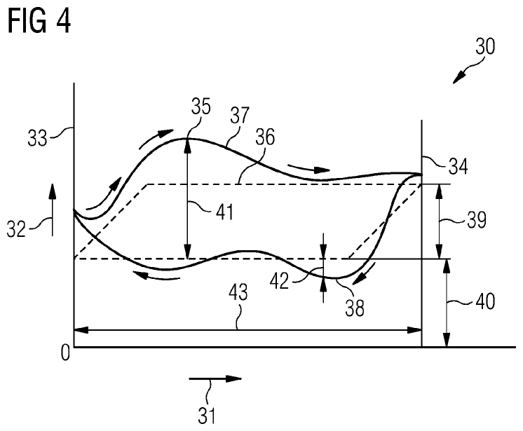

FIG. 3 shows an exemplary embodiment of a flowchart for a method for determining a load-travel graph from the power consumption of an electrically operated pump motor, having the following steps:
a) recording the current draw and the operating voltage of the motor 3 at a sampling frequency over at least one pump cycle, which can be assigned to in each case four operating phases of the subsurface pump 1, in the form of discrete measurement points containing current values, and determining the power consumption 72 of the motor 3 therefrom using power values,
b) determining a period duration 85 and a maximum 82 of the power consumption 72, corresponding to the torque maximum of the subsurface pump 1, for a pump cycle,
c) determining a reference phase angle for the kinematic converter 120 by using the properties of the kinematic converter 120 and the power consumption of the motor 3, which reference phase angle describes the relationship between the maximum 82 of the power consumption and the maximum of the force acting on the rod system of the subsurface pump 1,
d) ascertaining a torque characteristic from the power consumption of the motor 3 by using the properties of the kinematic converter 120,
e) determining the operating properties of the delivery pump 1 from the torque characteristic ascertained in step d) by using the period duration determined in step b) and the reference phase angle determined in step c).

The power values can be determined by way of the product of the discrete current values and the operating voltage.

The period duration 85 can be ascertained by way of the power values of the measurement points, for example using an approximated polynomial 80.

However, the period duration 85 can also be ascertained for example using a polynomial 80 that takes statistical mean values of the power values of the respective measurement points over at least five, preferably at least ten, particularly preferably at least fifty, pump cycles into account for interpolation points of the polynomial.

A reference value 81 at which there is a maximum for the change in the respective power value between two directly successive measurement points can be ascertained for the measurement points, and the period duration 85 is ascertained using the reference value 81.

The operating properties of the delivery pump 1 can be determined using a load-travel graph 30, 50, 54, 57, 60-65, which is ascertained from the torque characteristic ascertained in step d) by using the period duration determined in step b) and the reference phase angle determined in step c).

The reference phase angle can be determined in relation to the absolute maximum of the power values of the measurement points within a pump cycle.

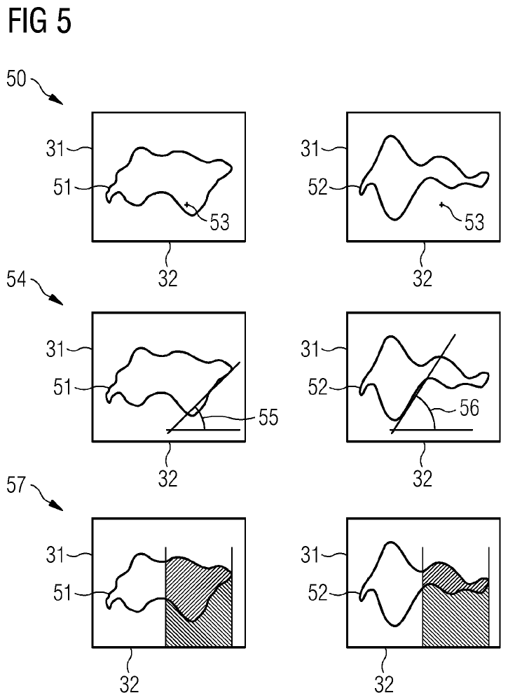

FIG. 4 to FIG. 6 show examples of load-travel graphs, which are frequently used to determine the operating properties of pumpjacks.

FIG. 4 shows a load-travel graph 30.

The x-axis plots the position 31 of the polished rod, and the y-axis plots the load 32 on the polished rod.

A lowest point of the pump stroke 33 and a highest point of the pump stroke 34 can be seen.

Furthermore, a peak of the polished rod 35 (PPRI) is shown.

A dashed line is used to show a card 36 of the polished rod for pump speed equal to zero.

Furthermore, a card 37 of the polished rod for pump speed greater than zero is shown.

A minimum load on the polished rod 38 (MPRL) is shown.

A gross plunger load 39 can also be read off.

Additionally, a weight of the rods in the fluid 40 can be determined, and also forces 41 and 42, and a pump stroke or pump travel 43.

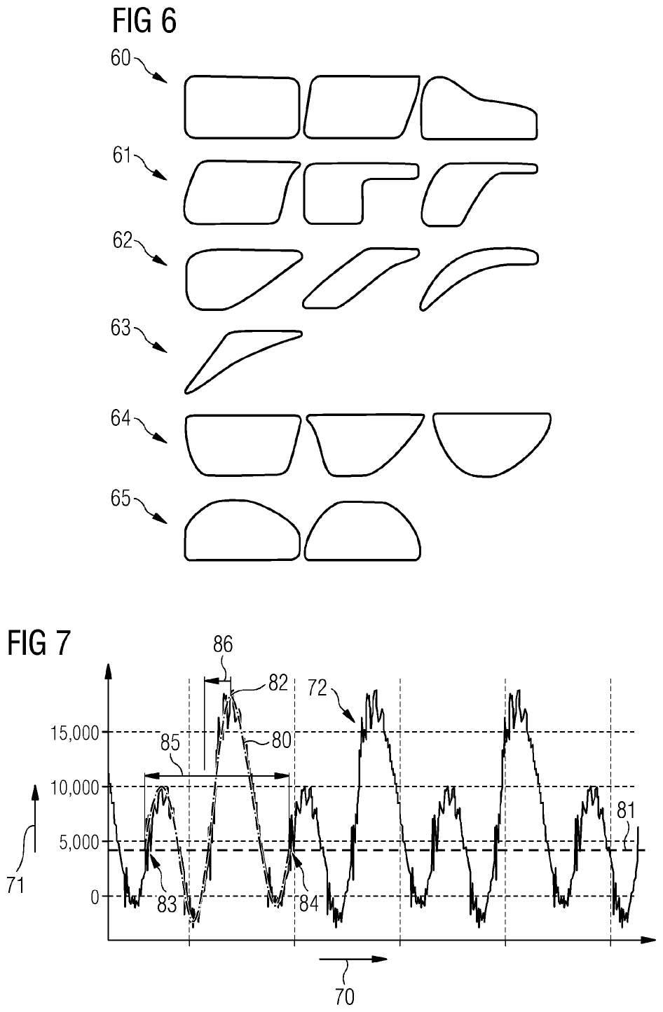

FIG. 5 shows load-travel graphs 50 showing rod load for specified value as a function of the load 32 on the polished rod over the respective position 31 of the polished rod.

A load-travel graph 51 shows operation of full pump power.

A load-travel graph 52 shows operation when the conveyed medium has been pumped dry.

A respective specified value 53 can be seen.

Furthermore, load-travel graphs 54 showing rod load for a change of operation as a function of the load 32 on the polished rod over the respective position 31 of the polished rod are shown, with respective angles 55, 56 being able to be read off.

Furthermore, load-travel graphs 57 showing rod load with the respective mechanical work of the rods are shown.

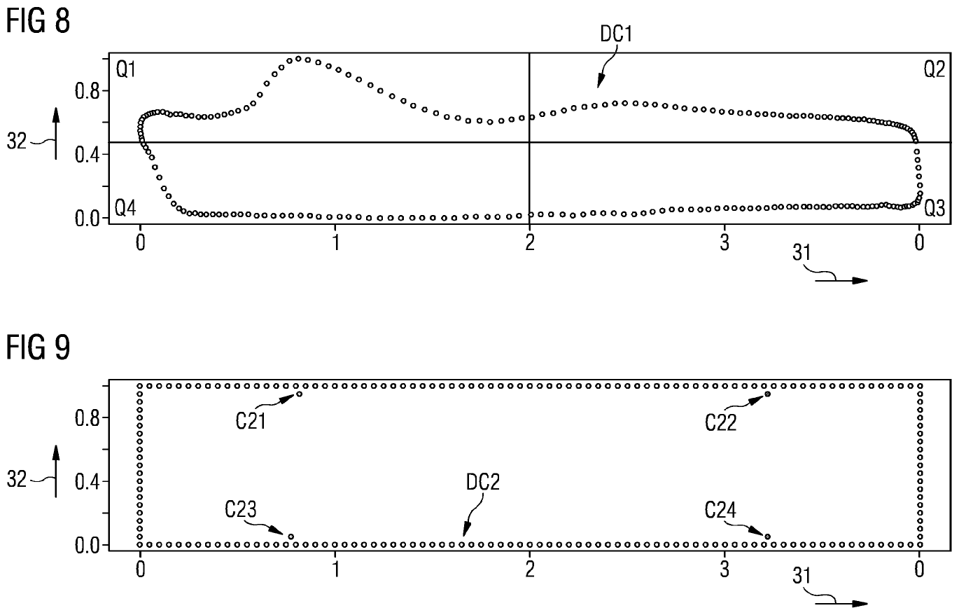

FIG. 6 shows load-travel graphs 60-65 for different operating states.

Graph 60 shows load-travel graphs for normal operation.

Graph 61 shows load-travel graphs for a fluid deposit.

Graph 62 shows load-travel graphs for the influence of gas in the underground deposit.

Graph 63 shows a load-travel graph for a stuck plunger.

Graph 64 shows a load-travel graph for a leak through a standing valve.

A graph 65 shows a load-travel graph for a leak through a moving valve.

The analysis device 140 can determine the operating property of the pump 1 from such load-travel graphs.

To this end, there is provision for the analysis device 140 to be provided with at least one model load-travel graph containing respective model curve points in a training mode.

The model load-travel graph is then normalized to a predefined reference variable by adjusting and standardizing the value ranges.

At least two subsets of the model curve points are then recorded as a first and at least one second feature on the basis of machine learning.

By way of example, a feature can be a specific curve characteristic or the location of curve points in the load-travel graph, intervals or even interval changes between individual curve points in the load-travel graph.

The application of machine learning and models produced therefrom, formed from a set of individual load-travel graphs, means that the statistical relevance of such features can achieve a particularly high level of significance.

The first and the at least one second feature is used to produce and train at least one random forest model by using a Kmeans algorithm.

The analysis device 140 normalises the operating curve points to the reference variable in an operating mode.

The analysis device 140 then checks whether there is a similarity between at least one subset of the operating curve points and the at least one random forest model.

If so, the operating property of the pump 1 is determined therefrom.

At least two random forest models can optionally be formed that have a low correlation with respect to one another.

The at least two random forest models having low correlation can be produced by randomly selecting a respective point from the set of operating curve points and providing said point from the set of operating curve points using substitution.

Alternatively, the at least two random forest models having low correlation can be produced by continuing to take a subset into account for breaking up a node in a random forest model.

As a further improvement, a sequence of the first and the at least one second feature within a pump cycle during operation of the pump 1 in the respective random forest model can be taken into account for determining the operating property of the pump 1.

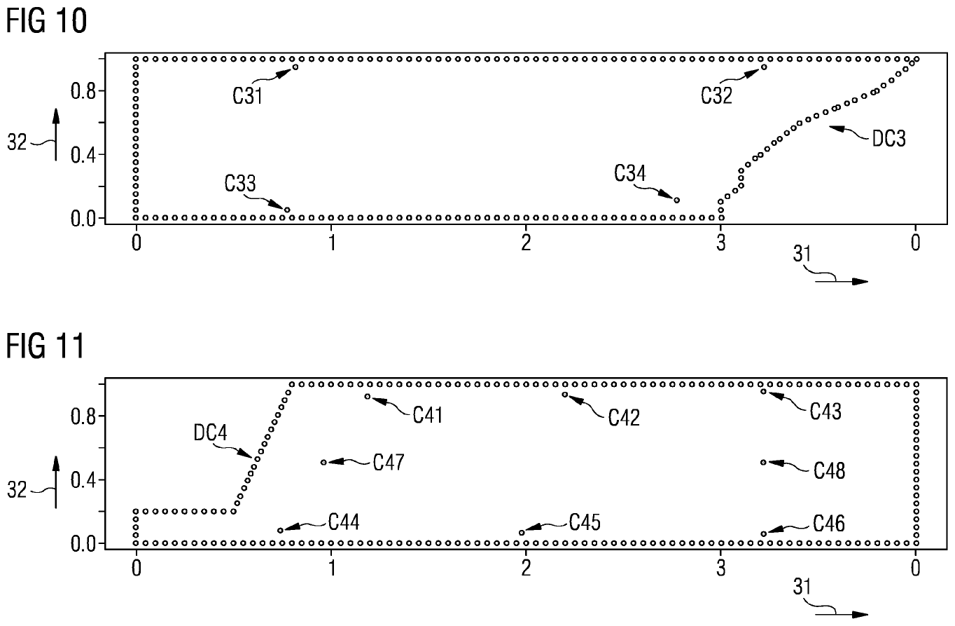

FIG. 7 shows an example of a temporal representation of a power characteristic of an electric drive motor for a pumpjack, which has been ascertained from the current draw and operating voltage of the motor 3.

The representation has a time axis 70 and an axis 71 for the amplitude of the current draw or power consumption.

A power consumption 72 is shown, for which it is possible to determine a zero point, or zero axis 80, and a polynomial for averaged power consumption 81.

A maximum value of the averaged power consumption 82 and zero crossings in the averaged power consumption 83, 84 can be ascertained for the polynomial 80.

Furthermore, a period duration 85 of the averaged power consumption can be determined for the polynomial 80.

This can be used to ascertain a phase angle 86 of the averaged power consumption, describing the relationship between the rotational movement of the motor 3 and the rod system 10 of the pump 1.

The ascertained values can be used to ascertain a corresponding load-travel graph in order to easily derive the operating properties of the pumpjack 1 therefrom.

It can be seen that the absolute value of the period duration 85 does not need to be taken into account in a further calculation of the load-travel graph.

In other words, determining the power consumption does not require the drive frequency of the pump motor to be taken into account.

The desired operating properties of the pumpjack 1 can be defined by one or more appropriate load-travel graphs in terms of “specified values”, which are produced and trained as a machine-learning-based model in a training mode. It is also possible to use load-travel graphs relating to other pumps in this regard.

By way of example, a question about the gas content in an oil-water-gas mixture from a mining site can be answered by creating and training a training model for a known mixture.

Different training models can be produced for different questions regarding the state of the pump and the components thereof, and also the composition of the conveyed mixture.

This training model is used as a reference to an operating load-travel graph.

Differences in the operating load-travel graph from the training model can be identified as an undesirable operating property.

In a training mode, a load-travel graph model containing model curve points is produced and trained by the analysis device 140 on the basis of machine learning.

A reference point check can optionally be performed by way of the following steps:
at least two predefined analysis ranges comprising at least some of the model curve points can then be determined in the load-travel graph model.

The model curve points can then be used to ascertain a reference point for at least one range from the analysis ranges, which reference point corresponds for example to the geometric center of the curve points in the respective range, or area formed by the curve points and the range limits, for example the graph axes.

In an operating mode, the analysis device 140 can check for the operating load-travel graph whether the at least one reference point determined in the training mode is enclosed within the area enclosed by the operating curve points.

If this is so, the operating property of the delivery pump 1 can be determined from the reference point identified as “enclosed”.

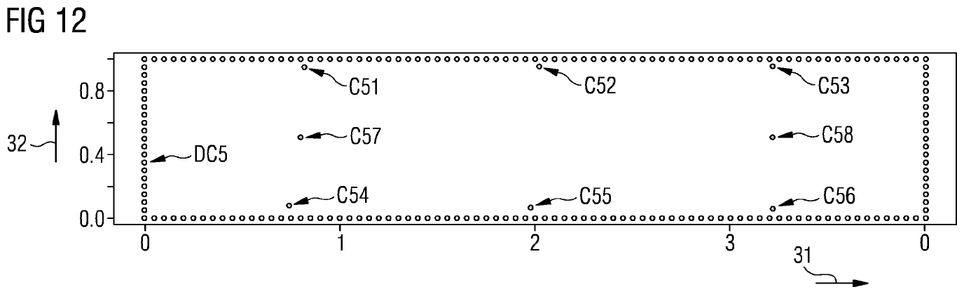

FIG. 8 shows an example of an operating load-travel graph DC1 containing curve points.

Four ranges Q1-Q2 in the form of quadrants are shown, separated by a value 2 for the travel 31 and a value 0.5 for the load 32.

The ranges can be directly adjacent to one another, for example, with the result that no ranges containing enclosed curve points arise without an association with reference points.

If desired, ranges can also be excluded, however, for example in order to prevent ranges that contain often error-prone curve points from being deliberately excluded in order to achieve an improvement in robustness for the determination of the operating property of the pump.

Range limits can also overlap, for example, and so a curve point can be assigned to multiple ranges.

The measurement curve points and the model curve points between two adjacent points on the respective curves can each have intervals that are on average at least 50%, preferably at least 80% and particularly preferably at least 95% of the greatest interval between two adjacent points on the respective curve.

This can result in approximately identical intervals between measurement curve points.

FIG. 9 shows an example of an operating load-travel graph DC2 containing curve points.

Analogously to the preceding figure, a centroid point C21-C24 is shown for each of four ranges, which centroid point corresponds to the geometric center of the curve points in the respective range, or area formed by the curve points and the range limits, for example the graph axes.

It can be advantageous if the regions overlap one another at least in part in order to better define a reference point for the range, for example if a range contains too few curve points.

Furthermore, at least one range can be defined, for example, for which there is provision for no enclosed curve point to be taken into account for the subsequent check.

In other words, a range can be excluded from closer inspection.

This can be advantageous if for example a range is known to be particularly susceptible to interference and/or is not or only slightly relevant for specific statements about the operating properties.

When the method according to the invention is applied, there can also be provision for example for multiple, mutually independent, checks on operating properties to be performed sequentially or in parallel.

It is advantageous if, after a similarity check by means of one or more Kmeans decision trees, an additional centroid check is performed according to the preceding embodiments.

Centroid-based post-processing allows operating properties to be identified particularly consistently and the identification rate for determining the operating property to be improved further.

Of course, there may also be provision for an iterative check by applying the method according to the invention in order to progressively confirm particular suspicions regarding a supposed operating property by adjusting the criteria for the training model.

The accuracy requirements can be increased gradually, for example, by increasing reference points in the respective subsequent training model, or alternative reference points can even be examined, for example in order to use a combination of two different training models to draw further conclusions about the operating property that is to be examined.

FIG. 10 shows an example of an operating load-travel graph DC3 containing curve points.

Analogously to the preceding figure, a centroid point C31-C34 is shown for each of four ranges, which centroid point corresponds to the geometric center of the curve points in the respective range.

FIG. 11 shows an example of an operating load-travel graph DC4 containing curve points.

In this example, eight ranges are shown, separated by a value 2 for the travel 31 and a value greater than or less than 0.5 for the load 32, there being provision for two further ranges for the value 0.5 on the load axis 32.

A centroid point C41-C48 is shown for each of the eight ranges, which centroid point corresponds to the geometric center of the curve points in the respective range.

FIG. 12 shows an example of an operating load-travel graph DC5 containing curve points.

Analogously to the preceding figure, a centroid point C51-C58 is shown for each of eight ranges, which centroid point corresponds to the geometric center of the curve points in the respective range.

### REFERENCE SIGNS

1 pumpjack
2 walking beam
3 prime mover, motor
4 gear reducer
polished rod
6 wellhead
7 flowline
8 casing
9 tubing
10 rod string
11 plunger
12 barrel
13 well
14 conveyed medium
15 cover tube with vertical grooves
16, 25 retaining device
17 self-aligning bearing
18 rotating tube with spiral grooves
19 recording tube
20 winged nut
21 plunger assembly
22 pump liner
23 calibrated rod
24 stylus
30 load-travel graph
31 position of the polished rod
32 load on the polished rod
33 lowest point of the pump stroke
34 highest point of the pump stroke
35 peak of the polished rod, PPRI
36 card of the polished rod for pump speed equal to zero
37 card of the polished rod for pump speed greater than zero
38 minimum load on the polished rod, MPRL
39 gross plunger load
40 weight of the rods in the fluid
41, 42 force
43 travel
50 load-travel graph showing rod load for specified value
51 pump, full power
52 pumped dry
53 specified value
54 load-travel graph showing rod load for change of operation
55, 56 angle
57 load-travel graph showing mechanical work of the rods
60 load-travel graph during normal operation
61 load-travel graph for a fluid deposit
62 load-travel graph for influence of gas
63 load-travel graph for stuck plunger
64 load-travel graph for a leak through a standing valve
65 load-travel graph for a leak through a moving valve 70 time axis
71 axis for amplitude of the current draw or power consumption
72 power consumption
80 selected zero point, or zero axis
81 polynomial for averaged power consumption
82 maximum value of the averaged power consumption
83, 84 zero crossing in the averaged power consumption
85 period duration of the averaged power consumption
86 ascertained phase angle of the averaged power consumption
100 pump system
110, 111 pump head
120 kinematic converter
130 recording means, recording device
140 computing device, analysis device
150 memory
Q1-Q4 range, quadrant
C21-C24, C31-C36, C41-C48
C51-C58 geometric center, centroid
DC1-DC5 load-travel graph, Dynacard

1. A computer-implemented method for determining an operating property of a pumpjack, wherein the pumpjack has a pump head, which is connected to a kinematic converter via a rod system, and the kinematic converter is driven by a motor during operation and a load-travel graph containing curve points is determined for the pumpjack by an analysis device using a recording device and is provided as an operating load-travel graph containing operating curve points, the method comprising:
in a training mode, providing by the analysis device at least one model load-travel graph containing respective model curve points, which graph is normalized to a predefined reference variable, and recording at least two subsets of the model curve points as a first and at least one second feature on the basis of machine learning, and producing and training the first and the at least one second feature in the form of at least one random forest model using a Kmeans algorithm, and
in an operating mode, normalizing the operating curve points to the reference variable and performing a check to ascertain whether there is a similarity between at least one subset of the operating curve points and the at least one random forest model, and, if so, determining the operating property of the pumpjack therefrom.

2. The method as claimed in claim 1,
wherein at least two random forest models are formed that have a low correlation with respect to one another.

3. The method as claimed in claim 2,
wherein the at least two random forest models having low correlation are produced by randomly selecting a respective point from a set of operating curve points and providing said point from the set of operating curve points using substitution.

4. The method as claimed in claim 2,
wherein the at least two random forest models having low correlation are produced by continuing to take a subset into account for breaking up a node in a random forest model.

5. The method as claimed in claim 2,
wherein a sequence of the first and the at least one second feature within a pump cycle during operation of the pumpjack in the respective random forest model is taken into account for determining the operating property of the pumpjack.

6. The method as claimed in claim 1,
wherein the first or the at least one second feature comprises an interval between operating curve points in the operating load-travel graph.

7. The method as claimed in claim 1,
wherein the motor is electrically operated and the recording device is designed to record electrical power consumption of the motor during the operation thereof, from which power consumption the operating properties of the pumpjack are determined.

8. A computer program stored on a non-transitory computer readable medium, comprising:
instructions stored thereon that, when executed by a computer, cause said computer to carry out the method as claimed in claim 1.

9. A non-transitory electronically readable data carrier comprising:
readable control information stored thereon, which control information comprises at least a computer program configured in such a way that it performs a method as claimed in claim 1 when the data carrier is used in a computing apparatus.

10. A non-transitory data carrier comprising:
the computer program as claimed in claim 8.

11. An analysis device comprising:
a memory for determining an operating property of a pumpjack,
wherein the analysis device is designed to analyze a provided operating load-travel graph using the method as claimed in claim 1 and to ascertain the operating property therefrom.

12. A pump system for determining an operating property of a pumpjack, wherein the pumpjack comprises a pump head, which is connected to a kinematic converter via a rod system, and the kinematic converter is driven by a motor during operation, the pump system comprising:
a recording device, designed to record and provide a load-travel graph relating to the pumpjack containing curve points, and
the analysis device as claimed in claim 11 designed to ascertain the operating property from the provided operating load-travel graph.
